(19) United States
(12) Patent Application Publication
(10) Pub. No.: US 2023/0022550 A1
(43) Pub. Date: Jan. 26, 2023

(54) IMAGE PROCESSING METHOD, METHOD FOR TRAINING IMAGE PROCESSING MODEL DEVICES AND STORAGE MEDIUM

(71) Applicant: BEIJING BAIDU NETCOM SCIENCE TECHNOLOGY CO., LTD., Beijing (CN)

(72) Inventors: Hanqi GUO, Beijing (CN); Zhibin HONG, Beijing (CN); Tianshu HU, Beijing (CN)

(21) Appl. No.: 17/937,979

(22) Filed: Oct. 4, 2022

(30) Foreign Application Priority Data
Oct. 12, 2021 (CN) 202111189380.4

(51) Int. Cl. G06T 11/60; G06T 9/00

(52) U.S. Cl. CPC G06T 11/60; G06T 9/002

(57) ABSTRACT

An image processing method includes: obtaining a first latent code by encoding an image to be edited in a Style (S) space of a Generative Adversarial Network (GAN), in which the GAN is a StyleGAN; encoding the text description information, obtaining a text code of a Contrastive Language-Image Pre-training (CLIP) model, and obtaining a second latent code by mapping the text code on the S space; obtaining a target latent code that satisfies distance requirements by performing distance optimization on the first latent code and the second latent code; and generating a target image based on the target latent code.

### CROSS REFERENCE TO RELATED APPLICATIONS

This application claims priority to Chinese Application No. 202111189380.4, filed on Oct. 12, 2021, the entire disclosure of which is incorporated herein by reference.

### TECHNICAL FIELD

The disclosure relates to a field of artificial intelligence technologies, especially to fields such as computer vision and deep learning technologies, and in particular to an image processing method, a method for training an image processing model, related devices and a storage medium.

### BACKGROUND

Image editing and processing technologies are widely used, and traditional editing methods require complex operations on images. Generative Adversarial Network (GAN) is a new image generation technology, which mainly includes a generator and a discriminator. The generator is mainly configured to learn the distribution of a real image to make the images generated by itself more realistic to fool the discriminator. The discriminator needs to determine whether the received pictures are true or false. Over time, the generator and the discriminator are constantly fighting, and eventually these two networks reach a dynamic equilibrium.

### SUMMARY

According to a first aspect, an image processing method is provided. The method includes: in response to an image editing request, determining an image to be edited and text description information of target image features;

obtaining a first latent code by encoding the image to be edited in a Style (S) space of a Generative Adversarial Network (GAN), in which the GAN is a StyleGAN;

encoding the text description information, obtaining a text code of a Contrastive Language-Image Pre-training (CLIP) model, and obtaining a second latent code by mapping the text code on the S space;

obtaining a target latent code that satisfies distance requirements by performing distance optimization on the first latent code and the second latent code; and

generating a target image based on the target latent code.

According to a second aspect, a method for training an image processing model is provided. The image processing model includes: an inverse transform encoder, a Contrastive Language-Image Pre-training (CLIP) model, a latent code mapper, an image reconstruction editor and a generator of a Style Generative Adversarial Network (StyleGAN), the method includes:

obtaining a trained inverse transform encoder by training the inverse transform encoder in a Style (S) space of a Generative Adversarial Network (GAN) based on an original image, in which the GAN is a StyleGAN;

obtaining a third latent code by encoding the original image in the S space by the trained inverse transform encoder, and converting the original image into a fourth latent code by an image editor of the CLIP model;

obtaining a trained latent code mapper by training the latent code mapper based on the third latent code and the fourth latent code;

obtaining the original image and text description information of target image features, obtaining text coding by encoding the text description information by a text editor of the CLIP model, and obtaining a fifth latent code by mapping the text coding on the S space by the trained latent code mapper; and

obtaining a trained image reconstruction editor by training the image reconstruction editor based on the third latent code and the fifth latent code.

According to a third aspect, an electronic device is provided. The electronic device includes: at least one processor and a memory communicatively coupled to the at least one processor. The memory stores instructions executable by the at least one processor, and when the instructions are executed by the at least one processor, the at least one processor is configured to perform the method according to the first aspect or the second aspect of the disclosure.

According to a fourth aspect, a non-transitory computer-readable storage medium storing computer instructions is provided. The computer instructions are configured to cause a computer to perform the method according to the first aspect or the second aspect of the disclosure.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a schematic diagram of the working principle of a StyleGAN model.

FIG. 2 is a flowchart illustrating an image processing method according to some examples of the disclosure.

FIG. 3 is a flowchart illustrating a method for training an image processing model according to some examples of the disclosure.

FIG. 4 is a schematic diagram illustrating a model according to some examples of the disclosure.

FIG. 5 is a schematic diagram illustrating a method for training an inverse transform encoder according to some examples of the disclosure.

FIG. 6 is a schematic diagram illustrating a method for training a latent code mapper according to some examples of the disclosure.

FIG. 7 is a block diagram illustrating an image processing apparatus according to some examples of the disclosure.

FIG. 8 is a block diagram illustrating an apparatus for training an image processing model according to some examples of the disclosure.

FIG. 9 is a block diagram illustrating an electronic device configured to implement embodiments of the disclosure.

### DETAILED DESCRIPTION

In order to facilitate understanding, the terms involved in this disclosure are introduced firstly.

Generative Adversarial Network (GAN) mainly includes a generator and a discriminator. The generator is mainly configured to learn the distribution of a real image to make the images generated by itself more realistic to fool the discriminator. The discriminator needs to determine whether the received pictures are true or false. In the whole process, the generator strives to make the generated images more realistic, while the discriminator strives to determine whether the pictures are true or false. Over time, the generator and the discriminator are constantly fighting, and eventually the two networks reach a dynamic equilibrium.

The image processing method combined with the GAN provides a convenient image editing manner in the field of image editing, and solves the complex operation problem of traditional image editing in a single mode. However, the current image processing method combined with the GAN still need to be improved to improve the use effect.

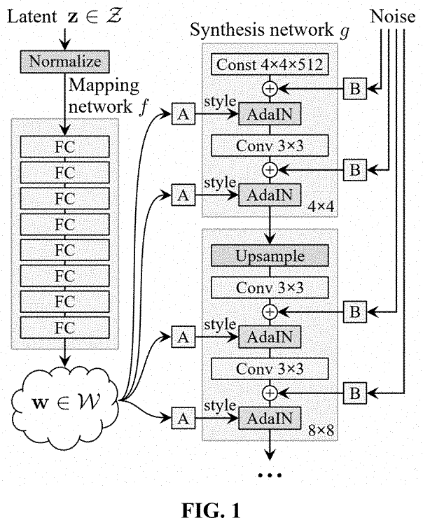

For Style-Based Generative Adversarial Network (StyleGAN) and the Style (S) space encoding, the StyleGAN is a model with powerful image generation capabilities. FIG. 1 is a schematic diagram illustrating working principle of a StyleGAN model. The StyleGAN obtains samples z by sampling the pictures distributed evenly, and then obtains a latent code w of a W space through an 8-layer fully connected network. By performing affine transformation on the latent code w, 18 latent codes {s_{i}}_{i=1}\hat{ }{18} are obtained and 18 corresponding network layers are generated for image generation, and the implementation process is shown in FIG. 1. Each of the 18 corresponding network layers {s_{i}}_{i=1}\hat{ }{18} is a sample of the S space, and all {s_{i}}_{i=1}\hat{ }{18} together constitute the S space. Each latent code in the S space corresponds to a generated image. Therefore, editing the latent code corresponding to the image to be edited in the S space can realize the editing of the image.

The Style Contrastive Language-Image Pre-training (StyleCLIP) mainly uses the Contrastive Language-Image Pre-training (CLIP) model to edit the latent code based on the language description inputted by the user, so as to achieve the purpose of editing images.

The CLIP model is a large-scaled model that is trained in advance using about 400 million image-text pairs by contrastive learning, which mainly includes two parts, a text encoder and an image encoder. The codes generated by the two encoders are represented by code_text_clip and code_image_clip respectively. When contents of a picture are consistent with contents described by the text, the distance between the code_text_clip and the code_image_clip generated by the CLIP model is small; otherwise, the distance between the two is large.

The following describes embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

The existing implementation scheme mainly adopts the StyleCLIP method, which uses the editing ability of the StyleGAN and the matching ability between text features and image features of the CLIP model to edit pictures based on the text description. There are mainly two specific methods, namely latent code optimization method and latent code mapping method, and the main idea of both is to use the latent code of the image to be edited as reference to search for a new latent code in a latent space of the StyleGAN, to obtain a generated image closest to the coding distance of the text description in the CLIP space.

There are two main problems with the existing StyleCLIP method. The first problem is that the independent editing ability is slightly insufficient, which mainly means that when modifying a certain part of the picture, the parts that are not mentioned in the text description cannot keep its characteristics unchanged, thus some unexpected changes and defects may occur. The second problem is that the execution speed is slow, which mainly means that when editing the picture for each text description, original image data needs to participate in the optimization process, and thus the processing time is long.

In order to solve the above problems, embodiments of the disclosure provide an image processing method, an image processing apparatus and a storage medium. By performing the latent code editing in the S space of StyleGAN, attributes other than the text descriptions can be well maintained in the process of editing the image. By directly searching for the code closest to the image and text, the optimal encoding can be achieved, which can improve the optimization speed.

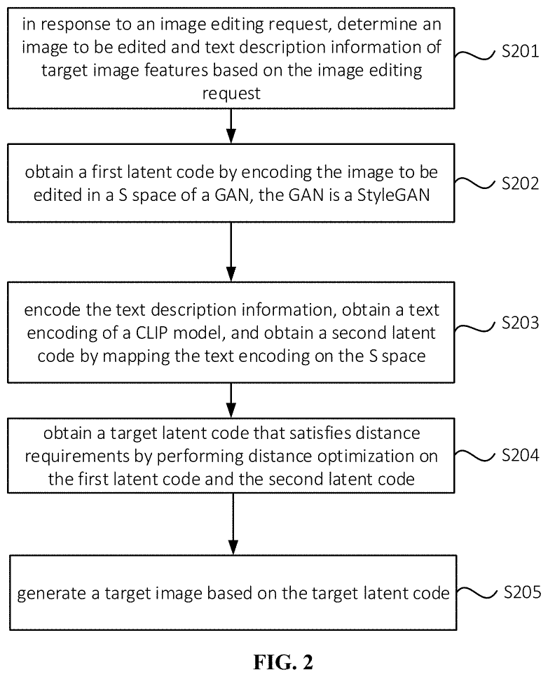

FIG. 2 is a flowchart illustrating an image processing method according to some examples of the disclosure. It is noteworthy that, the image processing method according to the disclosure can be performed by the image processing apparatus according to examples of the disclosure. The image processing apparatus can be included in an electronic device or can be an electronic device. As illustrated in FIG. 2, the image processing method may include the following.

At block S201, in response to an image editing request, an image to be edited and text description information of target image features are determined based on the image editing request.

In response to the image editing request, the text description information corresponding to the image to be edited is obtained, and the image can be edited based on the text description information.

At block S202, a first latent code is obtained by encoding the image to be edited in a Style (S) space of a Generative Adversarial Network (GAN). The GAN is a Style Generative Adversarial Network (StyleGAN).

The StyleGAN, the StyleGAN2 or other network models having similar functions can be selected and used, which is not limited.

In editing an image by the StyleGAN, the image needs to be converted into a latent code, and then the latent code is edited to realize the editing of the image.

In some examples, obtaining the first latent code by encoding the image to be edited in the S space of the GAN includes inputting the image to be edited into an inverse transform encoder, and obtaining the first latent code corresponding to the image to be edited generated in the S space by the inverse transform encoder.

The inverse transform encoder is supervised and trained based on image reconstruction errors. The image reconstruction errors are errors between original images and corresponding reconstructed images. The reconstructed images are obtained by performing image reconstruction, by a generator of the GAN, on latent codes output by the inverse transform encoder.

The function of the inverse transform encoder is to generate the first latent code corresponding to the image to be edited in the S space of the StyleGAN.

At block S203, the text description information is encoded, a text code of a Contrastive Language-Image Pre-training (CLIP) model is obtained, and a second latent code is obtained by mapping the text code on the S space.

The text description is input into the text editor of the CLIP model, and the text code is obtained. The text code is represented by code_text_clip.

The text code is input into the latent code mapper, and the text code is mapped in the S space of the StyleGAN to obtain the second latent code.

The role of the latent code mapper is to map the code_text_clip of the text description to the S space of the StyleGAN.

At block S204, a target latent code that satisfies distance requirements is obtained by performing distance optimization on the first latent code and the second latent code.

The first latent code and the second latent code are input into an image reconstruction editor, and the distance optimization is carried out on the first latent code and the second latent code, to obtain the target latent code that satisfies the distance requirements.

As a possible implementation, the image reconstruction editor optimizes a weighted distance sum of distances of the first latent code and the second latent code, to obtain the target latent code.

The role of the image reconstruction editor is to generate a code vector in the S space that is close to both the first latent code corresponding to the image and the second latent code corresponding to the text description, to realize the image editing function.

At block S205, a target image is generated based on the target latent code.

As a possible implementation, the target latent code is input into the generator of the StyleGAN, to generate the target image. For example, the target image that conforms to the text description can be generated by a generator of the StyleGAN2 based on the target latent code.

With the image processing method according to the disclosure, the latent codes of the image to be edited and the text description are obtained in the S space of the StyleGAN model. Since the latent codes in the S space has good decoupling effect, editing a certain part of the picture has less impact on other parts that do not need to be edited. The optimal encoding is achieved by directly searching for the target code with the closest distance from both the image and the text, and the data amount and dimension are significantly lower than that of directly processing the original image, which can effectively improve the optimization speed.

As a possible implementation, the image reconstruction editor includes a convolutional network, which is for example a mobilenet network model. It is noteworthy that, other convolutional network models can also be adopted, which is not limited here. The optimization process of the image reconstruction editor is equivalent to an optimization process of a small-scaled convolutional network, to minimize the weighted distance sum of the code vectors. The objective function of the optimization process is expressed as follows:

L=(s−s_{image})²+\lambda(s−s_{text})²

where s represents the target latent code, s_{image} represents the first latent code, s_{text} represents the second latent code, and \lambda represents an empirical value of a distance weight.

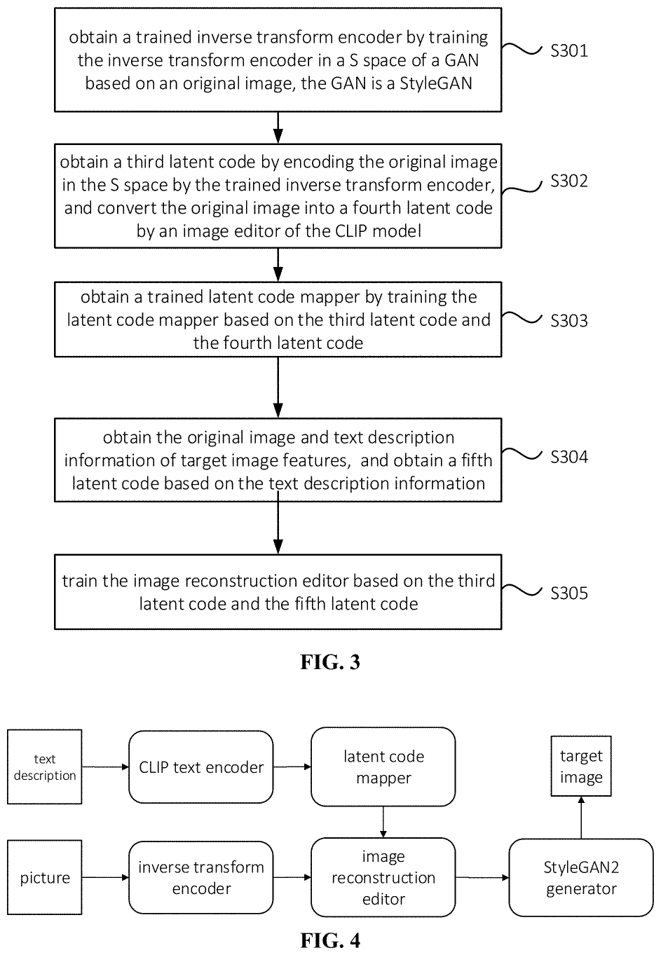

FIG. 3 is a flowchart illustrating a method for training an image processing model according to some examples of the disclosure. It is noteworthy that, as illustrated in FIG. 4, the image processing model includes an inverse transform encoder, a CLIP model, a latent code mapper, an image reconstruction editor, and a generator of a StyleGAN.

As illustrated in FIG. 3, the method for training an image processing model may include the following.

At block S301, a trained inverse transform encoder is obtained by training the inverse transform encoder in an S space of a GAN based on an original image. The GAN is a StyleGAN.

In the disclosure, the StyleGAN or the StyleGAN2 can be used.

At block S302, a third latent code is obtained by encoding the original image in the S space by the trained inverse transform encoder, and the original image is converted into a fourth latent code by an image editor of the CLIP model.

At block S303, a trained latent code mapper is obtained by training the latent code mapper based on the third latent code and the fourth latent code.

At block S304, the original image and text description information of target image features are obtained, text code is obtained by encoding the text description information by a text editor of the CLIP model, and a fifth latent code is obtained by mapping the text code on the S space by the trained latent code mapper.

At block S305, a trained image reconstruction editor is obtained by training the image reconstruction editor based on the third latent code and the fifth latent code.

The method for training an image processing model according to the disclosure is to train components of the model separately, so as to obtain a good training effect.

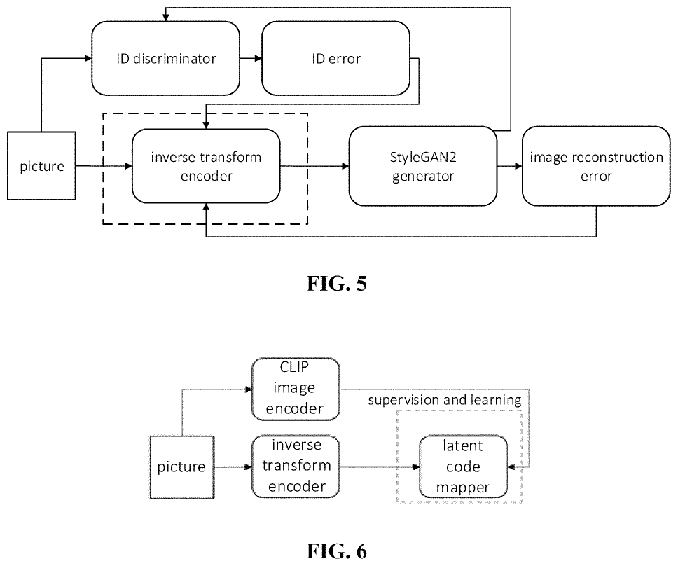

FIG. 5 is a schematic diagram illustrating a method for training an inverse transform encoder according to some examples of the disclosure. The structure of the inverse transform encoder includes multiple convolutional layers and a fully connected layer, or an existing network model with the same encoding function can be used, or a network structure composed of multiple convolutional layers and a fully connected layer can be generated by the user. In the disclosure, the mobilenet network model can be used, which is not limited here.

As a possible implementation, the process of generating the inverse transform encoder in combination with the generator of the StyleGAN2 model are used to supervise multiple metric dimensions such as the reconstruction quality of the generated picture, so as to realize learning of parameters of the corresponding layer of the inverse transform encoder. As illustrated in FIG. 5, the method for training the inverse transform encoder includes: training the inverse transform encoder based on the original image, in which constraint conditions of an objective function of the inverse transform encoder include an image reconstruction error.

The method for obtaining the image reconstruction error includes inputting the third latent code obtained through the conversion performed by the inverse transform encoder into the generator of the StyleGAN, to obtain a reconstructed image; obtaining the image reconstruction error between the original image corresponding to the third latent code and the reconstructed image; and adjusting parameters of the inverse transform encoder based on the image reconstruction error.

In some examples, the constraint conditions of the objective function of the inverse transform encoder also include an ID error, the method for training the inverse transform encoder also includes: inputting the original image and the reconstructed image into an ID discriminator, to obtain a first vector of the original image and a second vector of the reconstructed image; and determining an error between the first vector and the second vector as an ID error.

In addition, adjusting the parameters of the inverse transform encoder based on the image reconstruction error includes: adjusting the parameters of the inverse transform encoder based on the image reconstruction error and the ID error.

The ID discriminator has two inputs, one is the original image and the other is the reconstructed image.

Taking a face image as an example, A and B are two different person. The identity information (ID) of A and B can be identified. If A and B are different person, the IDs corresponding thereto are different. In this case, the ID discriminator can serve as a face recognition model, which can distinguish different person. The ID discriminator uses an identification network at present. Inputting an image of A results in generation of one vector, and inputting an image of B results in generation of another vector. If A and B are the same person, a distance between the two vectors is small, indicating that the ID error is small. If A and B are different person, the ID error is relatively large. As a constraint of the objective function of the inverse transform encoder, the ID error is used in determining whether two pictures are of the same person or not.

Taking face image editing as an example, the objective function used for optimization of the inverse transform encoder is expressed as follows:

L=|G(E(I))−I|+Loss_{id}(G(E(I)),I)

where I represents the input image, E represents the inverse transform encoder, G represents the generator of StyleGAN2, and Loss_{id} represents the ID error.

In the disclosure, the inverse transform encoder performs the latent code editing in the S space of StyleGAN2, which can well maintain attributes other than text descriptions when editing the image. The S space has a good decoupling performance for each feature. Existing technical solutions are in the W+ space whose decoupling performance is bad and thus if a certain dimension of the latent code changes, such as the color of the eyes changes in the W+ space, due to the poor decoupling performance, the color of other parts except the eyes will also change.

FIG. 6 is a flowchart illustrating a method for training a latent code mapper according to some examples of the disclosure. The structure of the latent code mapper is a linear mapper. Adopting the linear mapper is to maintain a relationship between the image and the text description. Taking the CLIP model as an example, if the picture is a black-haired person, and the text description of the picture describes that this is a black-haired person, then the vector generated by the picture and the vector generated by the text description will be close to each other. Otherwise, if the text description describes a white-haired person, the vector generated by the picture and the vector generated by the text description will be farther away from each other. In the case of linear mapping, after two vectors are linearly mapped to another space through a matrix, the relative distance between the two vectors will remain unchanged. The image editing method according to the disclosure needs to train the model under the condition that the relative distance between the two vectors remains unchanged. Therefore, a linear mapper is needed. As illustrated in FIG. 6, the method for training the latent code mapper includes: obtaining the trained latent code mapper by training the latent code mapper based on the third latent code and the fourth latent code, which includes the following. The latent code mapper is trained based on the fourth latent code. The constraint conditions of an objective function of the latent code mapper include a cosine distance between the third latent code and a sixth latent code output by the latent code mapper based on the fourth latent code. The parameters of the latent code mapper are adjusted based on the cosine distance.

The process of generating the latent code mapper in the disclosure is mainly based on supervising and training the latent code generated through the inverse transform performed by the above inverse transform encoder on the picture set, and the objective function used in the training is to measure the cosine distance between the code vector outputted by the latent code mapper and the code vector outputted by the inverse transform encoder. That is, the latent code mapper is required to map the latent code of the picture in the CLIP model space to the S space of the StyleGAN model, and make the distance from the latent code generated by the inverse transform encoder is close as much as possible.

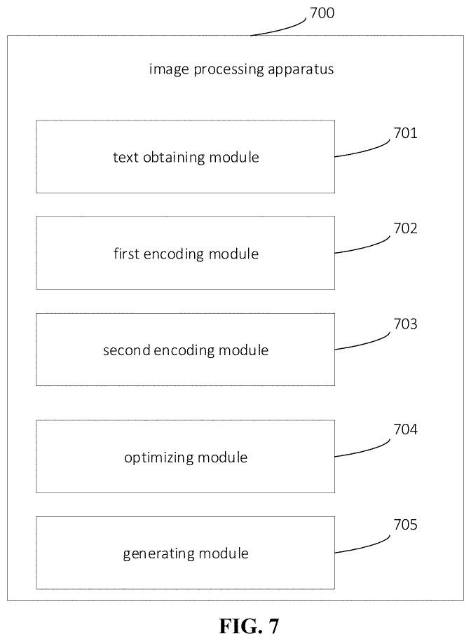

Corresponding to the above image processing method, FIG. 7 is a block diagram illustrating an image processing apparatus 700 according to some examples of the disclosure. As illustrated in FIG. 7, the image processing apparatus includes a text obtaining module 701, a first encoding module 702, a second encoding module 703, an optimizing module 704 and a generating module 705.

The text obtaining module 701 is configured to, in response to an image editing request, determine an image to be edited and text description information of target image features based on the image editing request.

The first encoding module 702 is configured to obtain a first latent code by encoding the image to be edited in an S space of a GAN. The GAN is a StyleGAN.

The second encoding module 703 is configured to encode the text description information, obtain a text code of the StyleCLIP, and obtain a second latent code by mapping the text code on the S space.

The optimizing module 704 is configured to obtain a target latent code that satisfies distance requirements by performing distance optimization on the first latent code and the second latent code.

The generating module 705 is configured to generate a target image based on the target latent code.

In some examples, the first encoding module 702 is further configured to: input the image to be edited into an inverse transform encoder, and obtain the first latent code corresponding to the image to be edited generated in the S space by the inverse transform encoder. The inverse transform encoder is supervised and trained based on image reconstruction errors. The image reconstruction errors are errors between original images and corresponding reconstructed images. The reconstructed images are obtained by performing image reconstruction, by a generator of the GAN, on the latent codes output by the inverse transform encoder.

In some examples, the second encoding module 703 is further configured to: obtain the text code by inputting the text description information into a text editor of the CLIP model to encode the text description information; and obtain the second latent code by inputting the text code into a latent code mapper to map the text code on the S space.

In some examples, the optimizing module 704 is further configured to: obtain the target latent code that satisfies the distance requirements by inputting the first latent code and the second latent code into an image reconstruction editor to perform the distance optimization on the first latent code and the second latent code.

In some examples, the image reconstruction editor includes a convolutional network, and an objective function of the image reconstruction editor is expressed as follows:

L=(s−s_{image})²+\lambda(s−s_{text})²

where s represents the target latent code, s_{image} represents the first latent code, s_{text}) represents the second latent code, and \lambda represents a distance weight empirical value.

In some examples, the generating module 705 is further configured to: input the target latent code into a generator of the GAN, to generate the target image.

Regarding the apparatus in the above embodiments, the specific manner in which each module performs operations has been described in detail in the method embodiments, and will not be described in detail here.

With the image processing apparatus according to the disclosure, when editing a certain part of the image, it has less impact on other parts that do not need to be edited, thereby effectively improving the optimization speed.

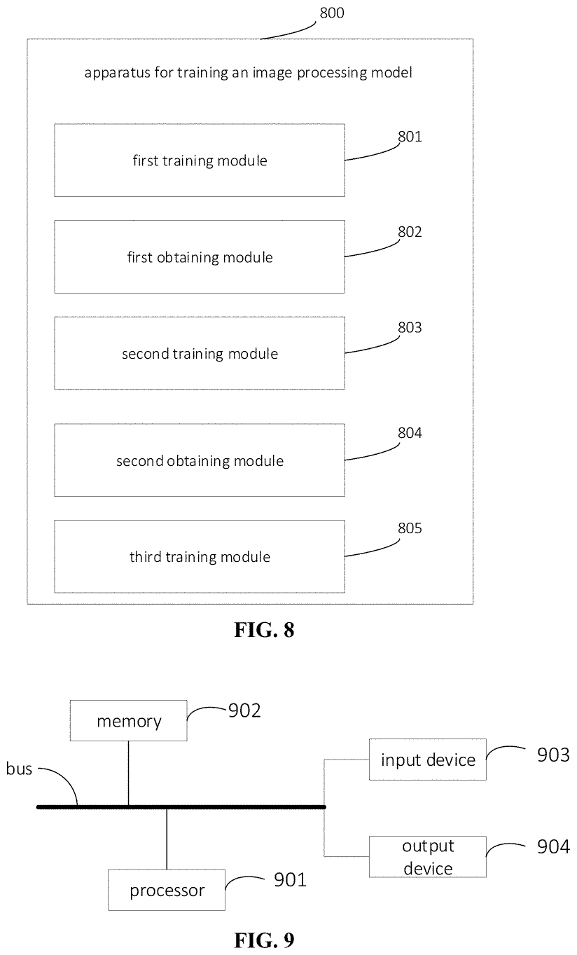

Corresponding to the above method for training an image processing model, FIG. 8 is a block diagram illustrating an apparatus 800 for training an image processing model according to some examples of the disclosure. As illustrated in FIG. 8, the apparatus for training an image processing model includes a first training module 801, a first obtaining module 802, a second training module 803, a second obtaining module 804 and a third training module 805.

It is noteworthy that, the image processing model includes an inverse transform encoder, a CLIP model, a latent code mapper, an image reconstruction editor and a generator of a StyleGAN.

The apparatus includes: the first training module 801, the first obtaining module 802, the second training module 803, the second obtaining module 804 and the third training module 805.

The first training module 801 is configured to obtain a trained inverse transform encoder by training the inverse transform encoder in an S space of a GAN based on an original image. The GAN is a StyleGAN.

The first obtaining module 802 is configured to obtain a third latent code by encoding the original image in the S space by the trained inverse transform encoder, and convert the original image into a fourth latent code by an image editor of the CLIP model.

The second training module 803 is configured to obtain a trained latent code mapper by training the latent code mapper based on the third latent code and the fourth latent code.

The second obtaining module 804 is configured to obtain the original image and text description information of target image features, obtain text code by encoding the text description information by a text editor of the CLIP model, and obtain a fifth latent code by mapping the text coding on the S space by the trained latent code mapper.

The third training module 805 is configured to obtain a trained image reconstruction editor by training the image reconstruction editor based on the third latent code and the fifth latent code.

In some examples, the first training module 801 is further configured to: train the inverse transform encoder based on the original image. The constraint conditions of an objective function of the inverse transform encoder include an image reconstruction error. The method for obtaining the image reconstruction error includes: inputting the third latent code obtained through the conversion performed by the inverse transform encoder into the generator of the StyleGAN, to obtain a reconstructed image; obtaining an image reconstruction error between the original image corresponding to the third latent code and the reconstructed image; and adjusting parameters of the inverse transform encoder based on the image reconstruction error.

In some examples, the first training module 801 is further configured to: input the original image and the reconstructed image into an ID discriminator, to obtain a first vector of the original image and a second vector of the reconstructed image; determine an error between the first vector and the second vector as an ID error; and adjust the parameters of the inverse transform encoder based on the image reconstruction error and the ID error.

In some examples, the second training module 803 is further configured to train the latent code mapper based on the fifth latent code, in which the constraint conditions of an objective function of the latent code mapper include a cosine distance between the third latent code output by the trained inverse transform encoder and the fourth latent code output by the latent code mapper; and adjust the parameters of the latent code mapper based on the cosine distance.

Regarding the apparatus in the above embodiments, the specific manner and effect of each module performing operations have been described in detail in the embodiments of the method, and will not be described in detail here.

According to the embodiments of the disclosure, the disclosure also provides an electronic device and a readable storage medium.

FIG. 9 is a block diagram of an electronic device used to implement the image processing method according to the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 9, the electronic device includes: one or more processors 901, a memory 902, and interfaces for connecting various components, including a high-speed interface and a low-speed interface. The various components are interconnected using different buses and can be mounted on a common mainboard or otherwise installed as required. The processor may process instructions executed within the electronic device, including instructions stored in or on the memory to display graphical information of the GUI on an external input/output device such as a display device coupled to the interface. In other embodiments, a plurality of processors and/or buses can be used with a plurality of memories and processors, if desired. Similarly, a plurality of electronic devices can be connected, each providing some of the necessary operations (for example, as a server array, a group of blade servers, or a multiprocessor system). A processor 901 is taken as an example in FIG. 9.

The memory 902 is a non-transitory computer-readable storage medium according to the disclosure. The memory stores instructions executable by at least one processor, so that the at least one processor executes the method according to the disclosure. The non-transitory computer-readable storage medium of the disclosure stores computer instructions, which are used to cause a computer to execute the method according to the disclosure.

As a non-transitory computer-readable storage medium, the memory 902 is configured to store non-transitory software programs, non-transitory computer-executable programs and modules, such as program instructions/modules corresponding to the image processing method according to the embodiments of the disclosure (for example, the text obtaining module 701, the first encoding module 702, the second encoding module 703, the optimizing module 704 and the generating module 705 shown in FIG. 7, or the first training module 801 and the first obtaining module 802, the second training module 803, the second obtaining module 804 and the third training module 805 shown in FIG. 8). The processor 901 executes various functional applications and data processing of the server by running the non-transitory software programs, instructions, and modules stored in the memory 902, to implement the image processing method in the above method embodiments.

The memory 902 may include a storage program area and a storage data area, where the storage program area may store an operating system and application programs required for at least one function. The storage data area may store data created according to the use of the electronic device for implementing the method. In addition, the memory 902 may include a high-speed random access memory, and a non-transitory memory, such as at least one magnetic disk storage device, a flash memory device, or other non-transitory solid-state storage device. In some embodiments, the memory 902 may optionally include a memory remotely disposed with respect to the processor 901, and these remote memories may be connected to the electronic device for implementing the method through a network. Examples of the above network include, but are not limited to, the Internet, an intranet, a local area network, a mobile communication network, and combinations thereof.

The electronic device for implementing the image processing method may further include: an input device 903 and an output device 904. The processor 901, the memory 902, the input device 903 and the output device 904 may be connected by a bus or in other ways, and the connection by a bus is taken as an example in FIG. 9.

The input device 903 may receive inputted numeric or character information, and generate key signal inputs related to user settings and function control of an electronic device for implementing the method, such as a touch screen, a keypad, a mouse, a trackpad, a touchpad, an indication rod, one or more mouse buttons, trackballs, joysticks and other input devices. The output device 904 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, application specific integrated circuits (ASICs), computer hardware, firmware, software, and/or combinations thereof. These various embodiments may be implemented in one or more computer programs, which may be executed and/or interpreted on a programmable system including at least one programmable processor. The programmable processor may be dedicated or general purpose programmable processor that receives data and instructions from a storage system, at least one input device, and at least one output device, and transmits the data and instructions to the storage system, the at least one input device, and the at least one output device.

These computing programs (also known as programs, software, software applications, or code) include machine instructions of a programmable processor and may utilize high-level processes and/or object-oriented programming languages, and/or assembly/machine languages to implement these calculation procedures. As used herein, the terms “machine-readable medium” and “computer-readable medium” refer to any computer program product, device, and/or device used to provide machine instructions and/or data to a programmable processor (for example, magnetic disks, optical disks, memories, programmable logic devices (PLDs), including machine-readable media that receive machine instructions as machine-readable signals. The term “machine-readable signal” refers to any signal used to provide machine instructions and/or data to a programmable processor.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or a computing system that includes any combination of such background components, intermediate computing components, or front-end components. The components of the system may be interconnected by any form or medium of digital data communication (e.g., a communication network). Examples of communication networks include: a local area network (LAN), a wide area network (WAN), the Internet and a block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve defects such as difficult management and weak business scalability in the traditional physical host and Virtual Private Server (VPS) service. The server may also be a server of a distributed system, or a server combined with a block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. An image processing method, comprising:
in response to an image editing request, determining an image to be edited and text description information of target image features of the image to be edited;
obtaining a first latent code by encoding the image to be edited in a Style (S) Space of a Generative Adversarial Network (GAN), wherein the GAN is a StyleGAN;
encoding the text description information, obtaining a text code of a Contrastive Language-Image Pre-training (CLIP) model, and obtaining a second latent code by mapping the text code on the S space;
obtaining a target latent code that satisfies distance requirements by performing distance optimization on the first latent code and the second latent code; and
generating a target image based on the target latent code.

2. The method of claim 1, wherein obtaining the first latent code by encoding the image to be edited in the S space of the GAN comprises:
inputting the image to be edited into an inverse transform encoder, and obtaining the first latent code corresponding to the image to be edited generated in the S space by the inverse transform encoder;
wherein the inverse transform encoder is supervised and trained based on image reconstruction errors, the image reconstruction errors are errors between original images and corresponding reconstructed images, and the corresponding reconstructed images are obtained by performing image reconstruction, by a generator of the GAN, on latent codes output by the inverse transform encoder.

3. The method of claim 1, wherein encoding the text description information, obtaining the text code of CLIP model, and obtaining the second latent code by mapping the text code on the S space comprises:
obtaining the text code by inputting the text description information into a text editor of the CLIP model to encode the text description information; and
obtaining the second latent code by inputting the text code into a latent code mapper to map the text code on the S space.

4. The method of claim 1, wherein obtaining the target latent code that satisfies the distance requirements by performing the distance optimization on the first latent code and the second latent code comprises:
obtaining the target latent code that satisfies the distance requirements by inputting the first latent code and the second latent code into an image reconstruction editor to perform the distance optimization on the first latent code and the second latent code.

5. The method of claim 4, wherein the image reconstruction editor comprises a convolutional network, and an objective function of the image reconstruction editor is expressed as follows:
L=(s−s_{image})²+\lambda(s−s_{text})²
where s represents the target latent code, s_{image} represents the first latent code, s_{text} represents the second latent code, and \lambda represents an empirical value of a distance weight.

6. The method of claim 1, wherein generating the target image based on the target latent code comprises:
inputting the target latent code into a generator of the GAN, to generate the target image.

7. A method for training an image processing model, wherein the image processing model comprises an inverse transform encoder, a Contrastive Language-Image Pre-training (CLIP) model, a latent code mapper, an image reconstruction editor and a generator of a Style Generative Adversarial Network (StyleGAN), the method comprises:
obtaining a trained inverse transform encoder by training the inverse transform encoder in a Style (S) space of a Generative Adversarial Network (GAN) based on an original image, wherein the GAN is a StyleGAN;
obtaining a third latent code by encoding the original image in the S space by the trained inverse transform encoder, and converting the original image into a fourth latent code by an image editor of the CLIP model;
obtaining a trained latent code mapper by training the latent code mapper based on the third latent code and the fourth latent code;
obtaining text description information of target image features of the original image, obtaining text coding by encoding the text description information by a text editor of the CLIP model, and obtaining a fifth latent code by mapping the text coding on the S space by the trained latent code mapper; and
obtaining a trained image reconstruction editor by training the image reconstruction editor based on the third latent code and the fifth latent code.

8. The method of claim 7, wherein training the inverse transform encoder in the S space of the GAN based on the original image comprises:
training the inverse transform encoder based on the original image with constraint conditions of an objective function of the inverse transform encoder, wherein the constraint conditions comprise an image reconstruction error;
wherein the image reconstruction error is obtained by:
inputting the third latent code into the generator of the StyleGAN, to obtain a reconstructed image;
obtaining the image reconstruction error between the original image corresponding to the third latent code and the reconstructed image; and
adjusting parameters of the inverse transform encoder based on the image reconstruction error.

9. The method of claim 8, wherein training the inverse transform encoder in the S space of the GAN based on the original image comprises:
inputting the original image and the reconstructed image into an ID discriminator, to obtain a first vector of the original image and a second vector of the reconstructed image; and
determining an error between the first vector and the second vector as an ID error;
wherein adjusting the parameters of the inverse transform encoder based on the image reconstruction error comprises:
adjusting the parameters of the inverse transform encoder based on the image reconstruction error and the ID error.

10. The method of claim 7, wherein obtaining the trained latent code mapper by training the latent code mapper based on the third latent code and the fourth latent code comprises:
training the latent code mapper based on the fourth latent code with constraint conditions of an objective function of the latent code mapper, wherein the constraint conditions comprise a cosine distance between the third latent code and a sixth latent code output by the latent code mapper based on the fourth latent code; and
adjusting parameters of the latent code mapper based on the cosine distance.

11. An electronic device, comprising:
at least one processor; and
a memory communicatively coupled to the at least one processor;
wherein, the memory stores instructions executable by the at least one processor, when the instructions are executed by the at least one processor, the at least one processor is configured to:
in response to an image editing request, determine an image to be edited and text description information of target image features of the image to be edited;
obtain a first latent code by encoding the image to be edited in a Style (S) Space of a Generative Adversarial Network (GAN), wherein the GAN is a StyleGAN;
encode the text description information, obtain a text code of a Contrastive Language-Image Pre-training (CLIP) model, and obtain a second latent code by mapping the text code on the S space;
obtain a target latent code that satisfies distance requirements by performing distance optimization on the first latent code and the second latent code; and
generate a target image based on the target latent code.

12. The electronic device of claim 11, wherein the at least one processor is configured to:
input the image to be edited into an inverse transform encoder, and obtain the first latent code corresponding to the image to be edited generated in the S space by the inverse transform encoder;
wherein the inverse transform encoder is supervised and trained based on image reconstruction errors, the image reconstruction errors are errors between original images and corresponding reconstructed images, and the corresponding reconstructed images are obtained by performing image reconstruction, by a generator of the GAN, on latent codes output by the inverse transform encoder.

13. The electronic device of claim 11, wherein the at least one processor is configured to:
obtain the text code by inputting the text description information into a text editor of the CLIP model to encode the text description information; and
obtain the second latent code by inputting the text code into a latent code mapper to map the text code on the S space.

14. The electronic device of claim 11, wherein the at least one processor is configured to:
obtain the target latent code that satisfies the distance requirements by inputting the first latent code and the second latent code into an image reconstruction editor to perform the distance optimization on the first latent code and the second latent code.

15. The electronic device of claim 14, wherein the image reconstruction editor comprises a convolutional network, and an objective function of the image reconstruction editor is expressed as follows:
L=(s−s_{image})²+\lambda(s−s_{text})²
where s represents the target latent code, s_{image} represents the first latent code, s_{text} represents the second latent code, and \lambda represents an empirical value of a distance weight.

16. The electronic device of claim 11, wherein the at least one processor is configured to:
input the target latent code into a generator of the GAN, to generate the target image.

17. An electronic device, comprising:
at least one processor; and
a memory communicatively coupled to the at least one processor;
wherein, the memory stores instructions executable by the at least one processor, when the instructions are executed by the at least one processor, the at least one processor is configured to perform the method for training an image processing model of claim 7.

18. A non-transitory computer-readable storage medium having computer instructions stored thereon, wherein the computer instructions are configured to cause a computer to perform the image processing method of claim 1.

19. A non-transitory computer-readable storage medium having computer instructions stored thereon, wherein the computer instructions are configured to cause a computer to perform the method for training an image processing model of claim 7.
